(19) United States
(12) Patent Application Publication
(10) Pub. No.: US 2008/0108748 A1
(43) Pub. Date: May 8, 2008

(54) Polyvinyl Alcohol Film And Method Of Producing The Same

(76) Inventors: Chad Buckley, Kingwood, TX (US); Brian Schuette, Winnetka, IL (US)

Correspondence Address: Chad Buckley, 5124 Blue Creek Drive, Kingwood, TX, 77345, US

(21) Appl. No.: 10/572,405

(22) PCT Filed: Mar. 4, 2003
(86) PCT No.: PCT/US03/06455

§ 371 Date: May 18, 2007

Related U.S. Application Data
(60) Provisional application No. 60/361,563, filed on Mar. 4, 2002.

(51) Int. Cl. C08L 29/04; C08L 31/04

(52) U.S. Cl. 524/612; 264/211

(57) ABSTRACT

This invention relates to improved water-soluble polymeric materials, and particularly to water-soluble films designed with a non-migratory plasticizer system for increasing the longterm use of the film. Specifically, the invention comprises a film comprising a blend of polyvinyl alcohol, a low molecular weight plasticizer, a high molecular weight plasticizer and a water-soluble or water-dispersible salt or mineral nucleating agent including any material which is water soluble, or substantially so, and capable of being incorporated into the film structure, preferable materials are salts or minerals. More particularly, the present invention relates to a system and method including providing a dissolvable film for packaging individually sealed dosages of materials. This present invention also relates to a method of producing a water-soluble film that can effectively act as the primary packaging for liquids, gels or pastes products containing 1-85% water by weight whilst keeping package integrity till the intended use of said product. These films can be produced by lamination of cold water-insoluble films to existing cold water soluble films, co-extrusion, solution casting, printing of a PE/PVA copolymer or a plasticized 99% Hydrolyzed PVA on an existing cold water-soluble film, or extrusion coating of PE/PVA copolymer on an existing cold water-soluble film.

### RELATED APPLICATIONS

This patent application claims priority from Provisional Patent Application 60/361,563 filed on Mar. 4, 2002.

### FIELD OF THE INVENTION

The present invention relates to polyvinyl alcohol (PVA) water-soluble films, and particularly to water-soluble films that are designed with a non-migratory plasticizer system for increasing the long term use of the film as well as a new film designed to package products containing 1-85% active or passive water.

### BACKGROUND OF THE INVENTION

Water-soluble films are commonly used in applications for single dose packages. These water soluble packages provide benefits including but not limited to providing precise dosing of materials contained within the packaging, providing an environmentally safe disposal of the packaging, convenient handling of the package's contents and user safety in that the packaging avoids the need for the user to open and expose the contents of the packaging. Such packaging is often utilized for containing highly reactive materials including pesticides, fertilizers and more recently soaps and detergents.

Caustic or potentially hazardous materials such as detergents, soaps, plant protection agents, dyes for the textile industry, concrete additives, and fertilizers are typically packaged in dispensers, such as high density polyethylene bottles, or other containers. After the chemical contents of the container have been spent, the empty dispenser or container must be disposed of in an environmentally safe way. This can be technically difficult and expensive.

Water-soluble films are useful in many applications in addressing these problems. When a product is needed, the package is immersed in water or some aqueous based medium to dissolve the contents of the package in the aqueous medium while additionally dissolving the packaging material itself. Such uses offer an environmentally attractive alternative to containers, which do not dissolve, and must therefore be disposed of after use.

In recent years the most active growth area for these films has been the consumer product market. Primary packaging from liquid laundry detergent accounts for 20-30% of all water-soluble film sold today. Several companies have launched products in Europe, which utilize a water-soluble film as the delivery system for the previous mention laundry detergents. Work is on going in the United States to determine if such a packaging system would be accepted in the market place.

This invention relates to poly-vinyl alcohol (PVA) homo and co-polymer based films and the incorporation of non-migratory plasticizer systems to retard and summarily halt the leeching of plasticizers. Plasticizers are incorporated into PVA films to increase the flexibility of the film. Commercially available PVA films are produced via melt extrusion or solution casting methods. In both processes a highly crystalline PVA (12-18% crystallinity for 88% hydrolyzed PVA and 30-50% crystallinity for 99+% hydrolyzed PVA) is mixed with a plasticizer to reduce the total amount of crystallinity of the finished, water-soluble film. In most cases, measurement by Differential Scanning Calorimetery (DSC) indicates that highly plasticized PVA films have a total heat capacity of 4.65 joules/gram or approximately 1.5% crystalline in nature. The percent crystallinity is dividing the heat capacity of the film by the heat capacity of a perfect crystal (277.4 joules/gram). The reduction of crystallinity by the addition of a plasticizer has proven to be effective in the formation of flexible films with excellent odor barriers and superior strength properties. However, the introduction of plasticizers into the PVA system is a non-covalent reaction and such plastification is only a temporary solution. Over time, the film begins to revert back to its highly ordered state and begins to crystallize (the gradual reduction in entropy driving plasticizer out of the system). To retard or halt this decrease in amorphous regions of the film, the PVA/plasticizer system must be kept intact.

This present invention also has implications for liquid products currently utilizing a water-soluble film system. The removal of propylene glycol or glycerin from their current formulations and their subsequent replacement by water would have tremendous cost saving to the manufacture as well as eventually to the consumer.

### DESCRIPTION OF THE PRIOR ART

The use of polyvinyl alcohol (PVA) water-soluble film is known in the prior art. More specifically, these water-soluble films are most commonly used in applications for single dose packages, notwithstanding the myriad of uses encompassed by the crowded prior art which have been developed for the fulfillment of countless objectives and requirements. Known prior water-soluble packaging include U.S. Pat. Nos. 5,529,888; 4,544,693; 4,528,360; 5,827,586; 6,166,117; Re.34,988; 5,051,222; 4,557,852; 3,198,740; 4,176,074; 4,973,416; 5,429,874; 6,133,214; 5,806,284; 5,827,586; 4,765,916; 6,071,618; UK Patent Nos. GB 2,320,456; and WO 98/26911.

These prior art films initially exhibit great water-solubility and flexibility. However, long-term aging studies have indicated that these films harden, become brittle and lose solubility.

U.S. Pat. No. 6,303,553 discloses a water-soluble package containing a powdered automatic dishwashing composition that can be added directly to an automatic dishwasher. Quantitative analysis has conclusively demonstrated that the polyvinyl alcohol (PVA) films disclosed therein tend to become harden, brittle and less soluble over time caused by the migration of plasticizers out of the “system”, thus increasing the overall crystalline nature of the film.

U.S. Pat. No. 5,429,874 discloses the use of salts in PVA films to increase the solubility of non PVA based polymers, which were not normally soluble at room temperature in water. However, this patent did not contemplate the use of such salts to maintain the plasticizer systems in a PVA film.

Commercially available are films, which can successfully package liquids, gels or pastes containing up to 24% water by weight in the formulation. Dickler Chemical proposes in U.S. Pat. No. 6,037,319 a method of formulating a liquid cleaner with 1-10% water by weight employing a water-soluble film as its primary packaging.

Procter and Gamble's U.S. Pat. No. 4,973,416 discloses the formulation of a liquid laundry detergent containing 10-24% water by weight, which is packaged in a PVOH, based water-soluble film. This patent demonstrates that formulations exceeding 24% water by weight lead to instability in the packaging including but not limited to loss of structural integrity, leaking or seeping of highly aqueous liquids overtime.

Liquid laundry detergents sold in Europe employing a water-soluble film as their primary packaging material, contain 0-10% water by weight with 20-30% active cleaning agent and 60-70% propylene glycol and or glycerin as the solvent of choice. In the US market, liquid laundry detergents contain between 60-85% water by weight, with 15-40% active reagent, and are packaged in a high-density polyethylene “HDPE” blow molded container. The use of water in Companies such as Kuraray of Japan have spent a significant amount of time and resources developing new PVA copolymers to counteract these perceived comparability issues. U.S. Pat. No. 6,166,117 details the polymerization and subsequent production of a PVA copolymer film. This film contains a sulfuric acid group modified PVA with 0.5-20 parts by weight. This patent discusses the packaging of biocides and acidic and chlorine containing chemicals with not interaction with the film.

This present invention allows for the packaging of such chemicals utilizing a standard PVA with sufficient plasticizers and additives to retain the desired physical and dissolution properties. The combination of nucleating agents and plasticizers produces a barrier to entry of opportunistic chemicals which normally attack the acetate groups on the polymer backbone, thus reducing cold water solubility. While small amounts of surface interaction may occur, the overall effectiveness of the film additive system remains intact.

### DEFINITIONS

“Water soluble” as used herein refers to a film structure, which is preferably totally water soluble or water-dispersible. However, films which are substantially water soluble but have relatively minor amounts of a material in the film structure which is not water soluble; films with materials which are water soluble only at relatively high water temperatures or only under limited pH conditions; and films which include a relatively thin layer of water insoluble material, are all included in the term “water soluble”.

“Film” is used herein to mean a film, web, or other packaging material of one or more layers, made by e.g. extrusion, co-extrusion, lamination (extrusion, thermal, or co-reactant solvent-based or water based adhesive system), coating, or other processes. Films are know from laundry detergents has significant cost savings when compared to the use of industrial chemicals like propylene glycol and glycerin. The rise in popularity of liquid detergents in the United States has lead to a large increase of HDPE waste going into public landfills. Therefore, the logical solution is to produce an environmentally friendly package that can make the economics more advantageous.

The method of premature film failure is described as a loss in flexibility and solubility after exposure to the materials contained in the water soluble package. With solution cast films, this mechanism has historically been mischaracterized as a chemical reaction. However a more accurate explanation is the dehydration of the film. The loss of a significant amount of water will lead to the observation of decreased flexibility and solubility. Moreover, extruded films have a similar problem with dehydration. Films produced by Aquafilms, Ltd. are humidified during the extrusion process to give temporary flexibility. PVA thermal plastic resins sold under the trade names of Vinex and P2 have the similar problems. While hydration during the manufacturing process is effective, it does not address the long term shelf life of PVA films.

P2, produced under patent number WO 98/26911, resins utilize a cold press method to produce a thermal plastic PVA which can be injection molded or utilize conventional blown film extrusion equipment. In this case, the cold water soluble resin is plasticized with glycerin at 6-8% and calcium carbonate is added at 5-15% as an anti-block agent. While these films show a similar formulations to this present invention, the long term shelf life of P2 is greatly reduced due to the dependence of post production hydration of the film. While exhibiting great initial flexibility with the introduction of moisture to the film, the contents of the package as well as the ambient atmosphere can remove the moisture from the PVA and show a premature loss in package integrity. the prior art and emanate for example from the group of (acetalized) polyvinyl alcohol, polyvinyl pyrrolidone, poly-ethylene oxide, gelatin and mixtures thereof Water-soluble film which forms a package has a thickness of 1 to 150 microns, preferably 2 to 100 microns, more preferably 5 to 75 microns and most preferably 10 to 50 microns.

“Caustic” is used herein to mean a chemical or mixture of chemicals with a pH of 7.0 or higher, i.e. alkaline.

“PVA” is used herein to polyvinyl alcohol including polyvinyl acetate compounds with levels of hydrolysis disclosed herein. Polyvinyl alcohols are polymers with the following general structure:

[—CH2-CH(OH)—]n

which also contain small amounts of structural units of the following type:

[—CH2-CH(OH)—CH(OH)—CH2]

Since the corresponding monomer, vinyl alcohol, is not stable in free form, polyvinyl alcohols are produced via polymer-analog reactions by hydrolysis and—on an industrial scale—above all by alkali-catalyzed transesterification of polyvinyl acetates with alcohols (preferably methanol) in solution. PVA s containing a predetermined residual percentage of acetate groups can also be obtained by these industrial processes. Commercially available PVA s (for example Mowiol(r) types, products of Kuraray) are marketed as white-yellowish powders or granules with degrees of polymerization of ca. 500 to 4,500 (corresponding to number average molecular weights of ca. 20,000 to 100,000) and have different degrees of hydrolysis of 98-99 or 87-89 mole-%. Accordingly, they are partly saponified polyvinyl acetates with a residual content of acetyl groups of ca. 1-2 or 11-13 mole-%.

“Polymer” is used herein to mean macromolecule made up of a plurality of chemical sub-units (monomers). The monomers may be identical or chemically similar, or may be of several different types. Unless a more specific term is used, “polymer” will be taken to include hereto- and homo-polymers, and random, alternating, block and graft polymers.

The term “water” is described as being active or passive. Active water is described as a water molecule in a liquid state having its full range of movement and is not complexed with any chemical or compound. Passive water is described as a water molecule complexed within a resin, gel, paste, chemical, suspension or compound in which it has a limited range of motion and reduces its solubility properties with respect to water-soluble film.

An example of passive water would be a gel produced by dissolving 88% hydrolyzed PVA producing a 1% by weight water solution with the addition of a catalytic amount of boron based compound. The boron acts to produce an ionic lattice in which active water is absorbed and or trapped into a complex of boron and PVA which limits it solvating properties, its range of motion and essentially makes the water passive. The addition of salts such as sodium chloride readily disturbs the ionic lattice network and releases the passive water converting it to active water. For the purposes of this invention the terms active and passive water are used interchangeably and are simply referred to as water.

“Copolymer” is referred as a polymer containing 2 or more chemically distinctive monomers polymerized together. For the purpose of understanding Exceval has three different chemical groups on the ethylene backbone, ethylene, alcohol and acetate. It is not therefore considered EVOH or PVA but a ter-polymer.

### DETAILED DESCRIPTION OF THE PREFERRED EMBODIMENT

The present invention provides for polyvinyl alcohol (PVA) which incorporates a non-migratory plasticizer system. For the purpose of this invention, the “system” comprises a PVA film comprised of a blend of a high molecular weight plasticizer, a low molecular weight plasticizer and either a mineral or salt nucleating agent. As used herein, low molecular weight plasticizer includes plasticizers with molecular weights less than 200 amu, while high molecular weight plasticizers includes plasticizers with molecular weights grater than 500 amu.

The present invention includes a film comprising of, a PVA and by weight, 0.1%-20% mineral and/or salt nucleating agent and 5-25% plasticizer, excluding water. Specifically, the PVA component of the film is preferably 60-94.4% by weight, the PVA being 50-99+ mole percent hydrolyzed with a degree of polymerization of 350-4000. Higher molecular weight polymers increase the physical properties of the corresponding PVA films as well as reduce their interaction with humidity. Ideally this plasticizer/PVA non-migratory system would have a degree of polymerization of 750 for a base PVA that is 87% hydrolyzed.

The mineral or salt nucleating agent can be any substantially inert powder, including: diatomaceous earth, talc, sodium sulfate, magnesium/aluminum silicates, calcium carbonate, silicone oxide, any of which having a particle size from 0.1-25 microns. This specific particle size and amount of nucleating agent, when properly dispersed, produces a highly ionic network throughout the film. This network tends to pool the plasticizers, and keeps the total entropy of the film system from decreasing. The film can be melt extruded, comprised of one or more layers via co-extrusion, lamination or the application of surface coatings. As a possible alternative, a solution-cast film might also be attainable, employing the present invention.

Preferred salt nucleating agents are alkali or alkaline earth salts such as sodium carbonate (Na2CO3); sodium sulfate (Na2SO4); sodium chloride (NaCl); potassium carbonate (K2CO3); potassium sulfate (K2SO4); and potassium chloride (KCL). One or more of these water-soluble salts can be included in the water-soluble film or the invention. The salt can be present in any suitable concentration in a given layer. Optimal concentrations will be governed to some extent by the nature of the salt, the nature of the base resin, the specific use of the film, processing and packaging equipment, and other factors.

The plasticizer “system” can be one of or a combination of conventional plasticizers, including propylene glycol, ethylene glycol, polyethylene glycol, glycerin, mannitol, pentaerythritol, and trimethylolpropane. A combination of polyethylene glycol, propylene glycol and glycerin is a preferred plasticizer system. The invention will be better understood by reference to the following detailed description. The incorporation of high molecular weight plasticizers reduces large crystalline regions within the film while low molecular weight plasticizers reduces the small crystalline regions.

The blend of both high and low molecular weight plasticizer as well as the nucleating agent significantly reduces the leeching of the plasticizer system in the film. Prior art describes a process in which glycerin mono oleate (GMO) is required in the compounding step to act as a dispersing agent for a dual plasticizer system containing glycerin and polyethylene glycol. The GMO would be utilized in a high-speed mixer to properly disperse the plasticizers prior to their introduction to a compounding extruder. This present invention uses a mineral or salt nucleating agent to effectively disperse the plasticizers though out the thermo plastic during the compounding process, thus reducing the number of the steps required producing a thermo plastic PVA compound.

The present invention provides for polyvinyl alcohol (PVA) compositions that can be prepared by conventional, solution mixing or melt extrusion processing methods and incorporates a non-migratory plasticizer system. With the compositions of the present invention, a non-migratory PVA/plasticizer film system incorporating mineral and/or salt nucleating agents to increase the long term use of the film.

Conventionally, solution-cast PVA films are considered unstable and difficult to formulate to minimize product interaction. This is due in part because the process of solution-casting PVA requires the addition of water, plasticizers, caustic liquids, and surfactants to the film system. This type of complex film system allows for the cross migration of opportunistic chemicals, which commonly causes premature failure in the film. Additionally, these types of films tend to dry out and become brittle over time reflecting their dependence on water as a plasticizer.

In general, extruded films have no such product interactions because they are produced via a compounding of PVA into a thermoplastic, contain no surfactants or caustic materials and do not require the use of water to plasticize the package. However, the ability of extruded films to retain plasticizers meets a similar fate to that of solution-cast films due to the formation of crystals in the extruded film that leeches plasticizers over time. The formulations of the present invention counteract the adverse effects of plasticizer migration.

After addition of the nucleating agent during the compounding step, the film can be melt extruded, comprising one or more layers via co-extrusion, lamination of the application of surface coatings. As a possible alternative, a solution-cast film might also be attainable employing the compositions of the present invention. The plasticizer “system” can be a combination of conventional plasticizers, including propylene glycol, ethylene glycol, polyethylene glycol, glycerin, mannitol, pentaerythritol, and trimethylolpropane.

For the production of a standard mono or multi-layer cold water soluble films of the present invention, the following commercially available products are readily available: 88% hydrolyzed PVOH is provided by Kuraray grade Poval 205. A PVA with similar molecular weight distribution as Poval 205 is GL05 provided by Nippon Gohsei. 98% hydrolyzed PVA is also provided by Nippon Gohsei N-300. Kuraray provides hydrolyzed PVA 73% with a grade Poval 505, which has a number average molecular weight of 28,000. Glycerin is provided for and commercially available from Proctor and Gamble under the trade name Moon Glycerin USP. Polyethylene glycol with a degree of polymerization of 400 as well as propylene glycol is made available from Dow Chemical. Chlorite and other magnesium/aluminum/ferrous silicates are also available from Luzenac America. The ideal particle size for the film of the present invention is between 1-1.7 microns. Below is example 1 of a mono layer film incorporating a non-migratory plasticizer systerm.

### EXAMPLE 1

| Compound | % by weight |
|---|---|
| Gohsenol GL05 | 60-90 |
| Glycerin | 5-25 |
| Polyethylene Glycol 400 | 1-5 |
| Talc | 1-5 |

Next, Example 2 is a polymeric film produced via melt extrusion. During the production of these products the low molecular weight plasticizer tends to volatilize at the die and cause the production area to become contaminated with smoke. To eliminate this problem a multi-layer blown film line is used with the outside layer containing only high molecular weight plasticizer which does not off gas during the manufacturing process.

### EXAMPLE 2

| | |
|---|---|
| Compound | % by weight |

Outside Layer 10% of total structure

| | |
|---|---|
| Poval 505c | 60-85 |
| Polyethylene Glycol 400 | 10-30 |
| Talc | 1-5 |

Core Layer 70% of total structure

| | |
|---|---|
| Gohsenol GL05 | 60-90 |
| Glycerin | 5-25 |
| Polyethylene Glycol 400 | 1-5 |
| Talc | 1-5 |

Inside Layer 20% of structure

| | |
|---|---|
| Gohsenol GL05 | 60-90 |
| Glycerin | 5-25 |
| Polyethylene Glycol 400 | 1-5 |
| Talc | 1-5 |

Example 2 utilizes the lower molecular weight PVA to decrease seal initiation temperature during the use of thermoforming, or vertical form seal packaging equipment. During the manufacturing process the bubble is converted to sheeting and the subsequent wound film places the sealing layer on the inside of the film. In this case the packaging equipment would only melt the inside layer during the sealing process, thus minimizing the films tendency to crystallize or thin at the seal. For example, a 72% hydrolyzed PVA has a melting point of 150° C. as compared to 185° C. for a 87% hydrolyzed PVA. Example 2 is suited for packaging powder with at ph range of 2-11.

One embodiment of this present invention also relates to the method of producing a water-soluble film for the primary packaging of liquids, pastes or gels which contain 1-85% water by weight in their respective formulations. Said film will keep structural integrity over time with no harmful side affects from packaging products containing 1-85% water by weight. The processes in which suitable film can be manufactured are extrusion coating, multi-layer blown or cast extrusion, multi-layer film lamination, printing of a coating on existing cold water-soluble film or solution casting methods. In order to prevent leaking or seeping of the water based liquid, gel or paste, an inner layer of the film has to be water insoluble at temperatures below 60°-80° C.

Commercially available is a polyethylene/polyvinyl alcohol copolymer produced by Kuraray LTD of Japan under the trade name EXCEVAL. This copolymer can be compounded into thermoplastic pellet with a suitable film produced via melt extrusion or solution. The film can be laminated or printed to an existing cold water-soluble film or co-extruded as a multi-layer. This copolymer has superior moisture vapor barrier properties when compared to conventional solution cast films produced from 98-99.9% hydrolyzed PVA due to their high content of water and surfactants. Extruded films produced from 98-99.9% hydrolyzed PVA function similarly to Exceval but dissolve in water at 60° C. rather than 80° C. as is the case with Exceval.

Alternatively the cold water-insoluble layer can be produced from conventional polymers such as polyethylene and polypropylene as well as others. The incorporation of a maleic anhydride grafted polymer would make these type of poly-olefins readily adhere to the cold water-soluble portion of the film. These types of grafted maleic anhydride polymers are commercially available form Dow Chemical, Equistar, Mitsui and Rohm and Haas. Although these olefin based polymers would function as well as the PE/PVA copolymer they are not readily dispersible in water. This limits there utility in most market places and is therefore not a preferred method of producing a barrier to water for this present invention.

One embodiment of this invention proposes the manufacturing of a multi-layered film of 0.1-7 mils in thickness. Said film structure would comprise a blend of PVA homo and copolymers and plasticizer systems as well as the incorporation of a polyethylene/polyvinyl alcohol copolymer as the cold water-insoluble portion of the film at temperatures below 80° C. The outer layers of the film would comprise a PVA base polymer with a degree of polymerization of 350-4000. This layer would have a degree of hydrolysis of 50-90% and would be designed to give wet-ability and rapid dissolution to the film structure. This portion of the film would be plasticized with a high molecular weight plasticizer such as polyethylene glycol as to reduce the chances of producing a harmful smoke during the manufacturing of the film.

The main composition of the inner layers would be produce from a 50-90% hydrolyzed PVOH, “cold water soluble”, with a degree of polymerization of 350-4000. The inside layer of the film would be produced from a 99% Hydrolyzed PVA or preferably polyethylene/polyvinyl alcohol (PE/PVA) ter-polymer and be in direct contact with the water based liquid, paste or gel. This hot water soluble, cold water insoluble, layer comprises the minority portion of the film structure and makes up to 10-30% of the total product by weight. Preferably, this layer would be indirect contact with the liquid, paste or gel and must be void of any pinholes. In one embodiment the method is the incorporation of a four-layer die with use of three extruders. In this instance, the extruder responsible for producing the hot water soluble layers will have the melt stream divided into two at the die. This would reduce any chance of pinholes produced during the manufacturing process and increase overall product integrity.

Similarly, this can be accomplished by employing a 5 layer cast or blown film line with a five or six layer die. In this case one or two small extruders would be used to produce the cold water-insoluble layers of the film. The five or six layer systems also afford the ability to produce a cold water-soluble layer in direct contact with the aqueous based liquid, gel or paste. The corresponding layers adjacent to this layer would be produced from a hot water soluble PVOH homo or copolymer. The advantage to this system is that the cold water-soluble layer would make the film readily available for the implementation of a water seal rather than the more conventional heat seal. The cold water-soluble layer would dissolve over time and leave the water seal intact with the aqueous liquid, gel or pasted being exposed to the correspond cold water insoluble layer.

For the purpose of this invention 50-99% of the film construction would be composed of 50-90% hydrolyzed PVOH or similar cold water soluble polymers known to the art. The remaining structure would utilize the PE/PVOH ter-polymer or a plasticized 99% hydrolyzed PVOH which is cold water-insoluble but soluble in water at temperatures greater than 60°-80° C. This part of the flexible package will give the desired strength and physical properties of the film whilst retaining the ability to package liquids, gels or pastes with 1-85% water by weight without the adverse effects stated in the Procter and Gamble U.S. Pat. No. 4,973,416.

The delivery mechanism begins with the pouch, package or sache being exposed to water. Given that the majority of the film structure is composed of 50-99% polymers, which are readily soluble in cold water, these layers should dissolve completely within 20-90 seconds depending on gauge and water temperature. The remaining cold water-insoluble layer will have poor structural integrity and the introduction of any agitation in the water would lead to immediate release of the packaged liquid, gel or paste into the solution. The residual layer will readily be dispersed within the given volume of water.

Exceval PE/PVOH copolymers are commercially available form Kuraray Co., Ltd. of Japan. Glycerin is provided for and commercially available from Proctor and Gamble under the trade name Moon Glycerin USP. Polyethylene glycol with a degree of polymerization of 400 as well as propylene glycol is made available from Dow Chemical. Chlorite and other magnesium/aluminum/ferrous silicates are also available from Luzenac America. The ideal particle size for the film of the present invention is between 1-1.7 microns.

The results of some of the tests run for enhancing the qualities of the PVOH films with an average gauge of 50 microns follow:

### EXAMPLE 3

### “Three Layer Film With Three Extruders”

| | |
|---|---|
| Compound | % by weight |

Layer A of Film Structure, Extruder 1, 20% of Film Structure

| | |
|---|---|
| Poval 505c | 60-90 |
| Polyethylene Glycol 400 | 10-30 |
| Talc | 1-5 |

Layer B of Film Structure, Extruder 2, 70% of Film Structure

| | |
|---|---|
| Gohsenol GM14 | 60-90 |
| Glycerin | 5-25 |
| Polyethylene Glycol 400 | 1-5 |
| Talc | 1-5 |

Layer C of Film Structure, Extruder 3, 10% of Film Structure

| | |
|---|---|
| Exceval | 100 |

### EXAMPLE 4

### “Four Layer Film With 3 Extruders”

| | |
|---|---|
| Compound | % by weight |

Layer A of Film Structure, Extruder 1, 20% of Film Structure

| | |
|---|---|
| Poval 505c | 60-90 |
| Polyethylene Glycol 400 | 10-30 |
| Talc | 1-5 |

Layer B of Film Structure, Extruder 2, 70% of Film Structure

| | |
|---|---|
| Poval 117 | 60-90 |
| Glycerin | 5-25 |
| Polyethylene Glycol 400 | 1-5 |
| Talc | 1-5 |

Layer C of Film Structure, Extruder 3, 5% of Film Structure

| | |
|---|---|
| Exceval | 100 |

Layer D of Film Structure, Extruder 3, 5% of Film Structure

| | |
|---|---|
| Exceval | 100 |

### EXAMPLE 5

### “Five Layer Film With 5 Extruders”

| | |
|---|---|
| Compound | % by weight |

Layer A of Film Structure, Extruder 1, 10% of Film Structure

| | |
|---|---|
| Poval 505c | 60-90 |
| Polyethylene Glycol 400 | 10-30 |
| Talc | 1-2 |

Layer B of Film Structure, Extruder 2, 25% of Film Structure

| | |
|---|---|
| Poval 117 | 60-90 |
| Glycerin | 5-25 |
| Polyethylene Glycol 400 | 1-5 |
| Talc | 1-5 |

Layer C of Film Structure, Extruder 3, 50% of Film Structure

| | |
|---|---|
| Poval 117 | 60-90 |
| Glycerin | 5-25 |
| Polyethylene Glycol 400 | 1-5 |
| Talc | 1-5 |

Layer D of Film Structure, Extruder 4, 10% of Film Structure

| | |
|---|---|
| Exceval | 100 |

Layer E of Film Structure, Extruder 5, 5% of Film Structure

| | |
|---|---|
| Poval 505c | 60-90 |
| Glycerin | 5-25 |
| Polyethylene Glycol 400 | 1-5 |
| Talc | 1-5 |

### EXAMPLE 6

### “Six Layer Film With 5 Extruders”

| | |
|---|---|
| Compound | % by weight |

Layer A of Film Structure, Extruder 1, 10% of Film Structure

| | |
|---|---|
| Poval 505c | 60-90 |
| Polyethylene Glycol 400 | 10-30 |
| Talc | 1-5 |

Layer B of Film Structure, Extruder 2, 25% of Film Structure

| | |
|---|---|
| Gohsenol GL05 | 60-90 |
| Glycerin | 5-25 |
| Polyethylene Glycol 400 | 1-5 |
| Talc | 1-5 |

Layer C of Film Structure, Extruder 3, 50% of Film Structure

| | |
|---|---|
| Gohsenol GM14 | 60-90 |
| Glycerin | 5-25 |
| Polyethylene Glycol 400 | 1-5 |
| Talc | 1-5 |

Layer D of Film Structure, Extruder 4, 5% of Film Structure

| | |
|---|---|
| Exceval | 100 |

Layer E of Film Structure, Extruder 4, 5% of Film Structure

| | |
|---|---|
| Exceval | 100 |

Layer F of Film Structure, Extruder 5, 5% of Film Structure

| | |
|---|---|
| Poval 505c | 60-90 |
| Glycerin | 5-25 |
| Polyethylene Glycol 400 | 1-5 |
| Talc | 1-5 |

The PVA film of an embodiment of the present invention may be made into packages such as pouches, bags, or other containers, by any known means, including thermoforming, lidstock, horizontal form-fill-seal, vertical form-fill-seal, vacuum skin packaging, or other means. The PVA film of one embodiment of the present invention preferably range in thickness from 10 to 200 microns and are more preferably between about 10 and 100 microns in thickness. Optimal thickness will depend at least in part on the intended end-use, packaging format, and cost considerations. Films of the invention can be optionally bi-axially or uniaxially oriented, by any suitable technique well known in the art, such as tenter frame or trapped bubble. The oriented film will be heat shrinkable, but can optionally be heat set or annealed to remove all or some of its heat shrinkability.

Having thus described the invention with particular reference to the preferred forms thereof it will be obvious that various changes and modifications may be made therein without departing from the spirit and scope of the invention as defined in the appended claims.

What is claimed is:

1. A water-soluble, polymeric film comprising Polyvinyl alcohol, a low molecular weight plasticizer, a high molecular weight plasticizer; and a mineral nucleating agent.

2. A water-soluble, polymeric film comprising Polyvinyl alcohol, a low molecular weight plasticizer, a high molecular weight, plasticizer, and a salt nucleating agent.

3. The water-soluble, polymeric film of claim 1 whereby the water-soluble film is used as primary packaging for liquids, pastes or gels comprising 1-85% water by weight

4. The water-soluble, polymeric film of claim 2 whereby the water-soluble film is used as primary packaging for liquids, pastes or gels comprising 1-85% water by weight

5. The water-soluble, polymeric film of claim 1 whereby the water-soluble film is a multi-layer film produced from lamination of cold water-insoluble films to existing cold water soluble films, co-extrusion, solution casting, printing of a PE/PVA copolymer or plasticized 99% PVA on an existing cold water-soluble film, or extrusion coating of hot water soluble polymers on an existing cold water-soluble film.

6. The water-soluble, polymeric film of claim 1 whereby the water-soluble film is a multi-layer film produced from lamination of cold water-insoluble films to existing cold water soluble films, co-extrusion, solution casting, printing of a PE/PVA copolymer or plasticized 99% PVA on an existing cold water-soluble film, or extrusion coating of hot water soluble polymers on an existing cold water-soluble film.

7. The water-soluble, polymeric film of claim 1 whereby the water content in the liquid, gel or paste being packaged is 60-85% by weight.

8. The water-soluble, polymeric film of claim 2 whereby the water content in the liquid, gel or paste being packaged is 60-85% by weight.

9. The water-soluble, polymeric film of claim 1 whereby the cold water-insoluble layer or layers are produced from an polyethylene/polyvinyl alcohol/polyvinyl acetate copolymer, a 95-99+% hydrolyzed PVA or a standard ethylene or propylene based polymer with the incorporation of a maleic anhydride graft polymer for adhesion to the cold water-soluble portion of the film.

10. The water-soluble, polymeric film of claim 2 whereby the cold water-insoluble layer or layers are produced from an polyethylene/polyvinyl alcohol/polyvinyl acetate copolymer, a 95-99+% hydrolyzed PVA or a standard ethylene or propylene based polymer with the incorporation of a maleic anhydride graft polymer for adhesion to the cold water-soluble portion of the film.

11. The water-soluble, polymeric film of claim 1 whereby the film can be produced such that a cold water-soluble layer is in direct contact with said aqueous based liquid, gel or paste as to produce a film capable of utilizing a water seal rather than the conventional heat seal.

12. The water-soluble, polymeric film of claim 2 whereby the film can be produced such that a cold water-soluble layer is in direct contact with said aqueous based liquid, gel or paste as to produce a film capable of utilizing a water seal rather than the conventional heat seal.

13. The water-soluble, polymeric film of claim 1 whereby a liquid laundry detergent can be formulated with water levels of 1-85% by weight and affectivity use said water-soluble film as its primary packaging.

14. The water-soluble, polymeric film of claim 2 whereby a liquid laundry detergent can be formulated with water levels of 1-85% by weight and affectivity use said water-soluble film as its primary packaging.

15. A method of producing a water-soluble, polymeric film comprising an extruder used to produce the cold water-insoluble layer in claim three can be divided into two separate melt streams and produce two separate layers adjacent to each other thus reducing the chance of producing pinholes and having premature failure of said film due to exposure of water to the cold water-soluble layers of the film.

16. The method of claim 15 whereby the film does not produced smoke during the extrusion process because a layer utilizing high molecular weight plasticizer only is the composition of the outside of the film.

17. The method of claim 15 whereby a low molecular weight or less hydrolyzed PVA can be used on the inside layer of a multi-layer film to decrease seal initiation temperature, and reduce thinning and crystallization at the seal.

18. The method of claim 15 whereby a liquid, paste or gel is packaged in multi-layer water soluble film that is produced via lamination, co-extrusion, solution casting or melt extrusion on an existing mono or multi layered film.

19. The water-soluble, polymeric film of claim 5 whereby the multi-layered film randomizes holes in the individual layers of the film to avoid leaks when film is elongated in the filling process.

20. The water-soluble, polymeric film of claim 6 whereby the multi-layered film randomizes holes in the individual layers of the film to avoid leaks when film is elongated in the filling process.

21. The method of claim 15 whereby the film is produced from a thermal plastic pellet produced from a carboxylated or sulfonated copolymer produced from the compounded polymer feedstock comprising mixing a polyjmer with at least one compounding agent and cold pressing the mixture to form the pellets.

22. The method of claim 21 wherein said thermal plastic is mono or co-extruded solution cast or printed on an existing water soluble film.
